(19) United States
(12) Patent Application Publication
(10) Pub. No.: US 2004/0179538 A1
(43) Pub. Date: Sep. 16, 2004

(54) System and method for delivery network resource management in a broadband

(76) Inventors: Douglas S. Makofka, Willow Grove, PA (US); Glenn Babecki, Pennington, NJ (US); Steve Didomenico, Mount Laurel, NJ (US)

Correspondence Address: Motorola, Inc., 101 Tournament Drive, Horsham, PA, 19044, US

(21) Appl. No.: 10/737,478

(22) Filed: Dec. 16, 2003

Related U.S. Application Data
(60) Provisional application No. 60/454,406, filed on Mar. 13, 2003.
(60) Provisional application No. 60/475,425, filed on Jun. 3, 2003.

(51) Int. Cl. H04L 12/28

(52) U.S. Cl. 370/398

(57) ABSTRACT

A scaleable digital broadband network capable of delivering broadcast digital video data, on-demand digital video data, video and audio telephony, and data originating or emanating with an end user personal computer, e.g. Internet data, is disclosed. The network of the present invention is partitioned into a service applications content management subsystem, a delivery network subsystem coupled to the applications management subsystem, and a network management subsystem coupled to the delivery network subsystem. The present invention permits the service applications content management subsystem to request delivery network resource devices for the manipulation, formatting, or any other necessary preparation of the deliverable data in the form of generic functional blocks. The service applications content management subsystem does not need to understand what actual devices are used to provide the requested functionality. The delivery network subsystem maps the functional block(s) requests to actual network resource devices and allocates such resource devices for use in data delivery.

### CROSS-REFERENCE TO RELATED APPLICATION

This application is related to U.S. Provisional Patent Applications Nos. 60/454,406 and 60/475,425, filed on Mar. 13, 2003 and Jun. 3, 2003, respectively, from which priority is claimed.

### FIELD OF THE INVENTION

The present invention relates to interactive broadband digital communications systems. More specifically, the present invention relates to a system and method which makes practical the management and operations of large media service delivery networks in broadband communications systems, where resources in the delivery network must be assigned “on-demand” to support overall system functionality.

### BACKGROUND OF THE INVENTION

Advances in broadband communications technology, e.g., Dense Wave Division Multiplexing (“DWDM”), are making more bandwidth available in broadband networks. In addition, gigabit Ethernet (“GIGE”) is allowing standard Internet protocol (“IP”) equipment to be used in the network to transport video-rate material. As a result of the above, the cost of video transport is rapidly decreasing. The result of these and other technology and market advancements make it possible to consider migrating from traditional broadcast-only video delivery to systems, to systems which enable delivery of all video material on-demand.

Furthermore, these systems can support Internet access and telephone service on the same network. As a result, the digital video data systems currently being developed will form a broad communications network providing broadcast digital video data, on-demand digital video data, video and audio telephony, and data originating or emanating with an end user's personal computer, e.g., Internet data (“inclusive network”), and other services yet to be determined.

In existing broadband video networks, a single service paradigm is typically supported. This single service paradigm basically comprises tuning a television (“TV”) program. In on-demand systems, inclusive networks, there are many service paradigms, which may not be known a priori by the delivery network. This greatly limits the assumptions that can be made by the delivery network about the data and video it is delivering. Since inclusive networks deliver many types of services, there is a need for the use of a wide range of resource devices for proper delivery of the requested datum to the end user. Such resource devices are dependant upon the type of data requested, the type of service that is being supported, and the end user's receiving device.

Conventional systems couple resource devices to particular data paths through the delivery network. Further, conventional systems segment the on-demand portion of the system from the broadcast portion of the system. Thus, conventional systems lack flexibility in the allocation of resource devices based upon bandwidth, and lack uncomplicated avenues to add new resource devices.

The conventional scheme is problematic because the on-going operation of a broadband inclusive network is different from the normal broadcast-oriented broadband networks. While adding broadcast-oriented services to existing broadband systems is marginally disruptive, adding new on-demand services can be extremely disruptive if the system is not structured properly to allow for such flexibility. Also, much more equipment is needed in an on-demand system. This leads to the need for a different management and operation structure for the on-demand systems, which also must be flexible.

What is needed is a system and method to efficiently discover, allocate, and provision/manage resource devices in an inclusive network. Such system and method must allow a multiplicity of service types to effectively use the resources of the inclusive network, and provide for the on-going evolution of the network, and the services that use the network. Such system and method must also allow new undetermined services and functions to be added without disruption of existing services and functions.

### SUMMARY OF THE INVENTION

An objective of the present invention is to provide a system and method which permits the on-going provisioning and management of a large service delivery subsystem comprised of devices which provide resources to a services/application subsystem in an overall digital video/data system. It is a further objective of the present invention to provide resource device management allowing for efficient use of available bandwidth. In order to achieve these objectives, as well as others which will become apparent in the disclosure below, the present invention assumes a partitioning of an overall system, for delivering digital data to end user devices over the network, into an Service/Applications Content subsystem (“SAC”), a delivery network subsystem (“DN”) coupled to the SAC, and a network management subsystem (“NM”) coupled to the DN and the SAC. It is further assumed that the sequence of steps for the delivery of such digital data is as follows: (1) a user is granted access to a service or application by the SAC; (2) the user, via a client device, requests a session (connection) to the service/application from the DN; (3) the DN passes the data requests to the SAC; (4) the SAC requests resources from the DN for the delivery of the service/application; (5) the DN finds and allocates resources to fulfil the request; and (6) the DN then alerts the SAC where to “enter” the DN with the service/application material, and instructs the end user (client) device were to access the service/application material. The above described partitioning and general sequence of steps is well known in the art. The present invention provides a system and method to be implemented in steps 4 through 6 above. The present invention provides a system and method in which a list of high-level DN subsystem resources are presented to the SAC, in such a manner that the SAC can use those resources for crafting services without understanding how the DN causes said resource requests to be fulfilled. These high-level resources become building blocks that can be used to craft new services. In accordance with the present invention, a proper set of building blocks allows many specific service types (e.g., Video On Demand, Network PVR, Switch Digital Broadcast) to share DN resources. Further, new undefined service types can also be crafted using the DN resources. This has the advantage that new service types can be added to the system quickly, without re-programming or otherwise changing the DN.

An exemplary embodiment of the present invention includes mapping of the high-level resource requests from the SAC into well-defined, standard functions that devices in the DN must perform. These functions are referred to as F-blocks herein. Such F-blocks may define a standard definition for the functionality of radio frequency (“RF”) modulators, upconverters, encryptors, inserters, multiplexers, jitter buffers, quality of service sharpers, transcoders, or any other functionality defined by the DN and needed to manipulate or otherwise prepare the data for delivery to an end user device. Thus, the DN allows the SAC to request resources in the form of F-blocks, which are mapped to F-block functionality.

In addition to mapping the high-level resource requests into F-blocks, the DN may determine a path through the network that contains devices that can provide all the F-blocks needed to satisfy the resource requests. These devices have available bandwidth and processing resources needed to handle the request assigned to them. In this exemplary embodiment, the system and method use topological information to determine how F-blocks are connected in the DN. In addition, each F-block type includes an allocation schema that allows the DN to allocate functionality at the F-block level.

In this exemplary embodiment, the DN implements the F-block interface as the main control interface for the resource devices. However, to accommodate resource devices that have other control interfaces, a Device Manager (“DM”) may be provided. The DM provides information that maps the F-block interface into a device-specific control interface, i.e., device driver, in such a manner that the resource device provides the required F-block functionality.

In another exemplary embodiment, a Delivery Network Configuration Module (“DNCM”) may be provided as part of the NM for the purpose of generating all configuration and provisioning information needed for equipment in the DN. In addition, the DNCM can generate the list of resources that can be requested by the SAC, the F-block to device mappings, and the topology information needed by the DN.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1 is a high-level context diagram of an exemplary system of the present invention;

FIG. 2 is a flow diagram showing the basic process flow of a session request in accordance with an exemplary embodiment of the present invention;

FIG. 3 is a detailed functional diagram of the media paths of an exemplary embodiment of the system of the present invention;

FIG. 4 is a detailed functional diagram of the control/command paths of an exemplary embodiment of the system of the present invention; and

FIG. 5 a flow diagram showing the basic process flow for adding a resource device in accordance with an exemplary embodiment of the present invention.

### DESCRIPTION OF A PRESENTLY PREFERRED EMBODIMENT

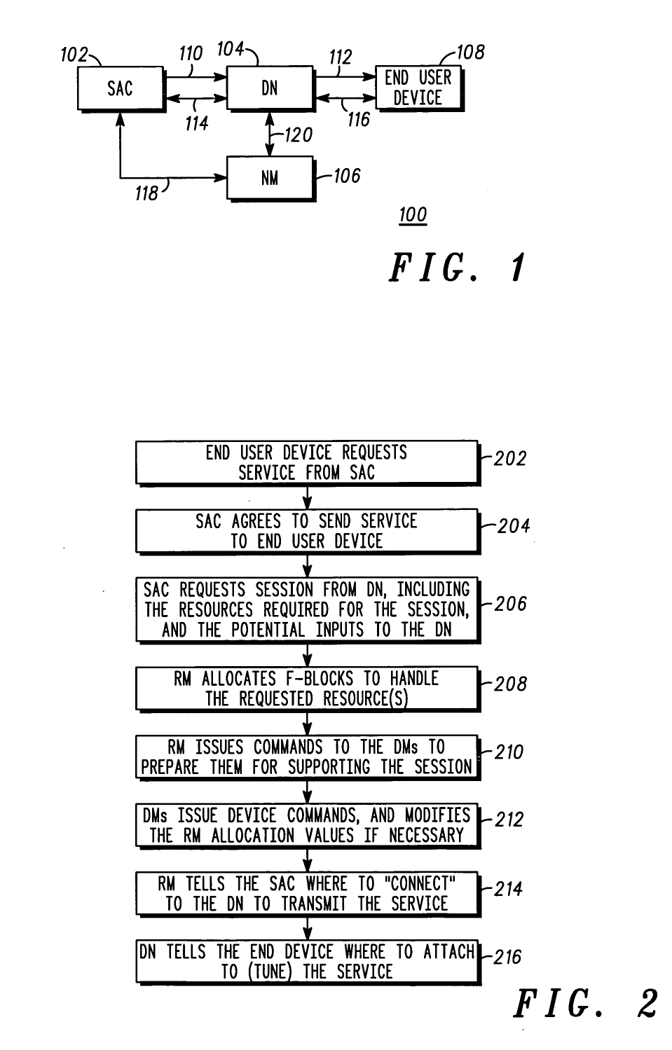

Referring to FIG. 1, in an exemplary embodiment, system 100 includes a service applications content subsystem (“SAC”) 102, a delivery network subsystem (“DN”) 104 coupled to the SAC 102, and a network management subsystem (“NM”) 106 coupled to the DN 104 and SAC 102. Preferably, the DN 104 is coupled to a plurality of end user devices 108. End user devices 108 may include digital video tuners, personal computers, voice over Internet protocol (“VOIP”) devices, and any other device capable of receiving a digital data signal of any type.

The above-described coupling of the SAC 102, DN 104 and NM 106 may be a physical point-to-point coupling or coupling over a network using transmitters and receivers in each subsystem respectively. Whether implemented over a network or point-to-point coupling, as used herein inputs and outputs of the SAC 102, DN 104 or NM 106 shall be referred to as receivers and transmitters, respectively.

The SAC 102 manages the digital data to be delivered to end user devices 108. The SAC 102 uses an organizational structure called a “service” to control how media is presented to the end user devices 108, billed, and accessed. For example, Video On Demand (“VOD”) is a media service well known in the art.

The SAC 102 requests resources from the DN 104 to accomplish the delivery of the media associated with services managed by the SAC 102. The DN 104 is the subsystem in which the core of the present invention's system and method resides. The purpose of the DN 104 is to provide a “session” that carries media associated with a service offered by the SAC 102 through the network (resource) devices of the DN 104 to end user devices 108. In conjunction with providing said sessions, the DN 104 provides a set of well-defined resources to the SAC 102 to facilitate in the delivery of media services to end user devices 108. The DN 104 provides a high-level interface for the SAC 102 to request sessions and their associated resource functions. Further, contrary to traditional digital data delivery systems, the initial session setup request originates from the SAC 104, rather then the end user device 108.

In this exemplary embodiment, the NM 106 is coupled to the DN 104 and the SAC 102, and provides them with the appropriate configuration information. The NM 104 gives the SAC 102 the set of resources that the DN 104 is capable of providing. The NM 106 may give the DN 104 its topology configuration, including a mapping of devices to F-Blocks. In addition, in this exemplary embodiment, all device configurations come from the NM 106 to ensure that the device configurations are consistent with the overall system configuration/design. Further, the NM 106 performs normal network management functions, such network functions being well known in the art.

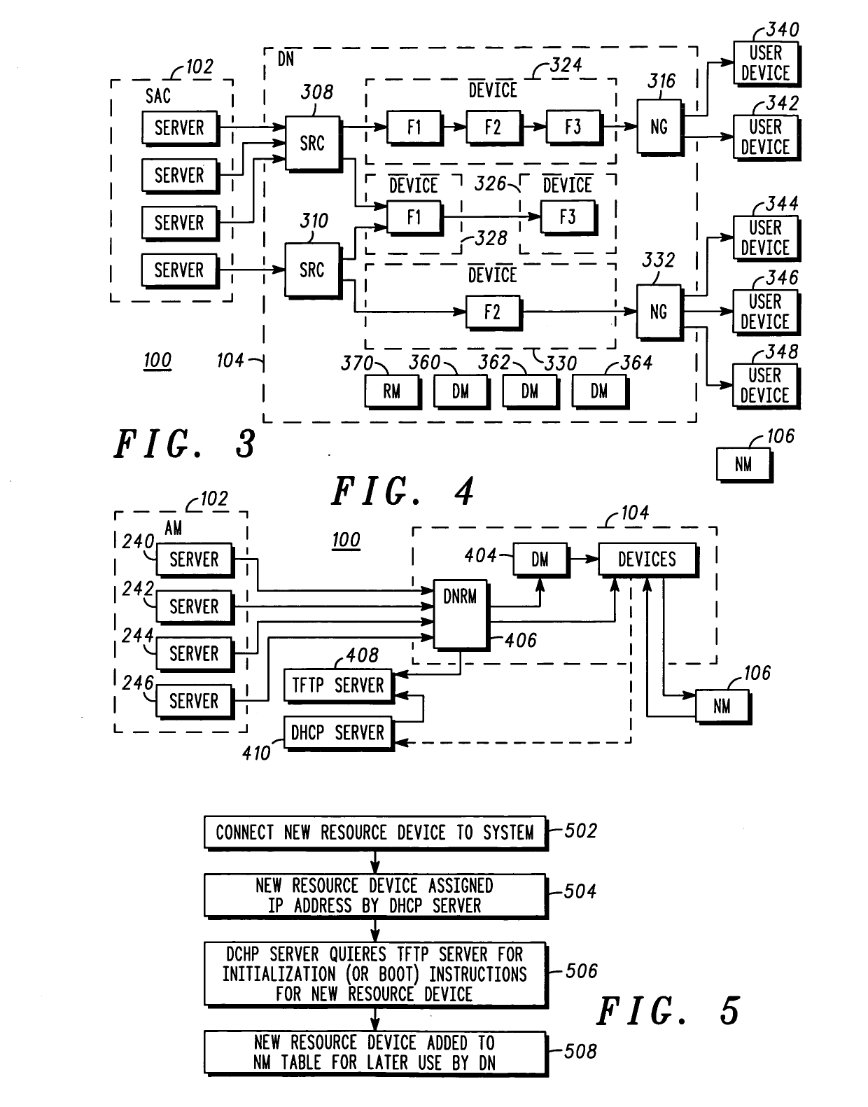

Referring to FIGS. 2 and 3, essential to the above description of the system and method of the present invention is the inventive network structure of the present invention, referred to herein as “chain topology.” In an exemplary embodiment, the present invention implements an inventive chain topology, where each DN source input (“SRC”) 308-310 will fan-out into chains of resources devices 324-330 and ultimately to a set of node groups (“NGs”) 316, 332. These chains are preferably implemented as GIGE subnets. The chain topology can be a graph that contains loops or cycles—a cyclic graph. The definition of a cyclic graph is well known in the art. In essence, a graph contains a cycle; if proceeding from one node to another, one can arrive at a previously visited node. In the preferred embodiment, each cycle must contain a specification of the maximum number of times the loop can be transversed when processing the chain. This specification is associated with the F-Block/Device that contains the ‘loop point’—the place where the graph is connected together to form the cycle. Preferably, the NM 106 gives a resource manager (“RM”) 370 in the DN 104 the chain topology. The RM 370 uses the chain topology to find a chain from the SRCs 308-310 given in the session request, to the NG 316, 332, with which the end user device 340-348 is associated, that contains resource devices hosting the F-blocks that are needed to satisfy the resource set given in the session request received from the SAC 102.

If a SAC 102 and a DN 104 are “completely connected” then there is only one SRC 328, as any server in the SAC 102 can ‘hit’ any chain in the in the DN 104. However, if a SAC 102 and a DN 104 are not “completely connected”, then there must be at least one SRC 308-310 for every orthogonal subnet between the DN 104 and the SAC 102. Further, each NG 316, 332 represents a part of a broadband cable topology where RF signals are combined and split. Each NG 316, 332 can be viewed as a “leg” of the broadband network. Preferably, each end user device 340-348 is associated with a NG 316, 332. The RM 370 maintains this association in this exemplary embodiment. The mechanism by which the RM 370 acquires this association is beyond the scope of this invention.

In this exemplary embodiment, the present invention also provides for a Delivery Network Configuration Module (“DNCM”) that creates and manages the chain topology, and resides in the NM 106. The DNCM allows new F-blocks to be defined; associates F-blocks to resource devices; and creates the F-block chains, SRC definitions, and NG definitions. The DNCM checks the chain topology for consistency, completeness, and performs any other design validations which may be necessary.

The DNCM accepts F-block implementation packages (“FIP”). FIPs define the potential mappings between specific products and F-blocks. The information contained in the FIPs is sufficient to allow the DNCM to completely generate resource device configuration information based on a chosen F-block-to-resource-device mapping, and the location of a resource device in the F-block chain. Preferably, FIPs may contain Java objects and XML-based configuration information. The DNCM creates several packages of information including: (1) a DN system design including F-block chain topology; (2) a set of configuration files for every resource device in the F-block chain; and (3) a SRC-resource table that describes the resources that are available from each SRC in the DN. As described above, the F-block chain topology is sent to the RM 370. Further, the SRC-resource table is sent on request to a requesting entity in the SAC 102. Alternatively, the SAC 102 may function without requesting the SRC-resource table. In this second instance, the DNCM sends the SRC-resource table to the RM 370. Devices in the SAC 102 can then request the SRC-resource table from the RM 370, as needed. In this alternative embodiment, no interaction between the SAC 102 and the DNCM is required.

In operation, when an end user device 340-348 desires video material (digital data), an end user device 340-348 requests a service from the SAC 102, in step 202. Upon such service request, the SAC 102 selectively agrees to grant the end user device 340-348 access to the service, in step 204. The SAC 102 then requests a session from the DN 104 for the purpose of delivering the service to the end user device, in step 206. The session request contains a list of resources that the DN 104 must associate with the session. Also, the session request includes an ordered list of potential sources (“SRC”) 308-310 that the SAC 102 can delivery (“hit”) with the media content that the session will carry. As described above, the SRCs 308-310 are an abstraction for an input to the DN 104. The SAC 102 can hit the SRC 308-310 if there is network connectivity between a device in the SAC 102 containing the media required for the session, and the SRC 308-310. The source list is given an order of preference from the SAC 104, meaning, if at all possible, the DN 104 should use the first SRCs 308-310 listed. In this exemplary embodiment, a SRCs 308-310 is preferably a GIGE switch or router. Further, the session request includes the end user device 340-348 that is the target of the session. In step 208, RM 370 receives the session request, and fulfils it by finding a chain of resource devices that begins with one of the SRCs 308-310 given in the request, and that terminates in the NG 316, 332 that contains the end user device 340-248 given in the request. In addition, the chain must contain resource devices 324-330 capable of providing the resources identified in the session request, including communication bandwidth. To accomplish said task, the RM 370 must map the resource requests into the standard functions supported by the DN 104. These standard functions are represented by abstractions called F-blocks. Examples of F-blocks include modulators, up-converters, multiplexers, de-jitter buffers, ad insertion, and transcoding. All of these functions are well known in the art. The behaviour of every resource device 324-330 in the chains must be described by standard F-block definitions. In FIG. 3, F-blocks are represented by the boxes labelled F1, F2, F3. The RM 370 views the resource device chains from the F-block perspective. For example, for the purpose of resource allocation, the RM 370 views the chain consisting of SRC 308, resource device 324 and NG 316 as a chain of SRC 308, F1, F2, F3, and NG 316. Thus, if a session request specifies resources that map to functions F1, F2, F3, targets an end user device 340-348 residing in NG 316, and has a source list containing SRC 308, the RM 370 can use the chain that contains resource device 324 to satisfy the request. Further, each F-block type has an allocation scheme that allows the RM 370 to reserve resources in the resource device 324-330 associated with the F-block. In steps 208 and 210, respectively, the RM 370 allocates (reserves) the necessary resources at the F-block level, and then instructs the device manager (“DM”) 260-264 associated with the resource device 324-330 to perform the F-block function in the resource device 324-330. As described above, the DM 260-264 knows how to translate F-block-specific commands into device-specific commands in order to have the desired functions carried out in a specific resource device 324-330. At an appropriate point in processing the F-block command, the DM 260-264 will instruct the RM 370 as to any necessary F-block allocation adjustments that may be required due to differences between the generic F-block allocation strategy and the device-specific allocation strategy, in step 212. Ideally, no adjustments will be needed; however, this mechanism gives device vendors more latitude in resource device 340-348 implementation and overall compatibility with the DN 104. While this is the currently preferred embodiment, alternatively a resource device 324-330 could implement the F-block commands directly, and not require a separate device manager.

At this point the RM 370 can inform the SAC 102 which SRC 308-310 to use for the connection, in step 214. Preferably, this step includes the IP and port address of a resource device 324-330 that is accessible via the selected SRC 308-310. IP and port addressing are well known in the art. Once the SAC 102 accepts the connection, the RM 370 instruct the targeted end user device 340-348 how to connect (tune) to the session just established, in step 216. In this way, the end user device 340-348 receives the requested video material/digital data.

The system and method of the present invention further provide for the easy addition of additional resource devices. Referring to FIGS. 4 and 5, a new resource device may be added to the system 100 by connecting the new resource device to the system 100 network, in step 502. Preferably, network of system 100 is Gigabit Ethernet (“GigE”) or other high speed network configuration. The new resource device added will be recognized by the DHCP server 410 and given an IP address, in step 504. The DCHP server 410 will then preferably query the trial file transfer protocol (“TFTP”) server 408, to retrieve the information needed to initialize or boot the new resource device, in step 506. The new device will then be automatically added to a table of available resource devices in the NM 106 and defined in the NM 106 for later use in F-block mapping and resource device allocation by the DN 104, in step 508.

The above system and method may be implemented by many computer languages commonly known in the art and may operate on many computer platforms which include both volatile and non-volatile memory storage devices. Further, the above-described inventive technique may be implemented on conventional computer readable medium including, but not limited to, diskettes; CD-ROMS; or modulated radio frequency, electromagnetic or optical waves, for example.

Although the invention has been described herein by reference to an exemplary embodiment thereof, it will be understood that such embodiment is susceptible of modification and variation without departing from the inventive concepts disclosed. All such modifications and variations, therefore, are intended to be encompassed within the spirit and scope of the appended claims.

We claim:

1. A system for delivering digital data to end user devices over a network, said system comprising:
a service application management subsystem, said service application management subsystem structuring a manner in which at least one end user device can access said digital data; and
a delivery network subsystem coupled to said service application management subsystem, said delivery network subsystem receiving and selectively delivering said digital data from said service application management subsystem to a requesting end user device in response to requests in the form of generic, high-level, resources from said service application management subsystem, said requests being mapped, by said delivery network subsystem, into functional blocks corresponding to unique resource devices.

2. The system of claim 1 further comprising a network management subsystem coupled to said delivery network subsystem and said service application management subsystem, said network management subsystem providing configuration information to said service application management subsystem and said delivery network subsystem.

3. The system of claim 1, wherein said delivery network subsystem further comprises:
a delivery network resource device manager, said delivery network resource device manager handling requests for said resource devices in the form of said functional blocks and allocating said resource devices to perform a function of said functional blocks.

4. The system of claim 3, wherein said delivery network subsystem further comprises:
a device manager coupled said delivery network resource device manager, said device manager translating functional block behaviour requests into specific commands for said resource devices.

5. The system of claim 1, wherein said functional blocks comprise one of a radio frequency modulator, upconverter, encryptor, inserter, multiplexer, jitter buffer, quality of service sharper, and transcoder function.

6. The system of claim 1 further comprising a plurality of service groups, each of said service groups having a unique set of said resource devices.

7. The system of claim 6, wherein each of said plurality of service groups comprises one or more node groups, said node groups providing at least one of input and output for at least one end user device.

8. A method for delivering digital data to end user devices over a network, said method comprising:
receiving a request for digital data in a service application content management subsystem, said service application management subsystem structuring a manner, in the form of a session request, in which at least one end user device can access said digital data; and
receiving said session request in a delivery network subsystem from said service application management subsystem, said delivery network subsystem receiving and selectively delivering said digital data from said service application management subsystem to said end user device in response to said session request in a form of generic, high-level, resources from said service application management subsystem, said session request being mapped, by said delivery network subsystem, into functional blocks corresponding to unique resource devices; and
delivering said digital data to said end user device.

9. The method of claim 8 further comprising the step of said service application management subsystem receiving said request for digital data from said at least one end user device.

10. The method of claim 8, wherein said step of providing said corresponding resource devices to receive said digital data and process said session request further comprises:
receiving said functional blocks in a delivery network resource device manager, said delivery network resource device manager handling requests for said resource devices in the form of said functional blocks and allocating said resource devices to perform a function of said functional blocks.

11. The method of claim 10, wherein said step of allocating resource devices further comprises:
translating functional block behaviour requests into specific commands for said resource devices in a device manager.

12. The method of claim 10, wherein said step of requesting functional blocks comprises one of requesting a radio frequency modulator, upconverter, encryptor, inserter, multiplexer, jitter buffer, quality of service sharper, and transcoder function.

13. The method of claim 8, wherein said step of delivering said digital data to said end user device further comprises sending said digital data to a node group.

14. The method of claim 13, wherein said step of delivering said digital data to said node group further comprises sending said digital data from said node group to said end user device.

15. A computer-readable carrier including computer program instructions that instruct a computer to perform the steps of:
receiving a request for digital data in a service application content management subsystem, said service application management subsystem structuring a manner, in the form of a session request, in which at least one end user device can access said digital data; and
receiving said session request in a delivery network subsystem from said service application management subsystem, said delivery network subsystem receiving and selectively delivering said digital data from said service application management subsystem to said end user device in response to said session request in a form of generic, high-level, resources from said service application management subsystem, said session request being mapped, by said delivery network subsystem, into functional blocks corresponding to unique resource devices; and
delivering said digital data to said end user device.

16. The computer-readable carrier of claim 15 further comprising the step of said service application management subsystem receiving said request for digital data from said at least one end user device.

17. The computer-readable carrier of claim 15, wherein said step of providing said corresponding resource devices to receive said digital data and process said session request further comprises:
receiving said functional blocks in a delivery network resource device manager, said delivery network resource device manager handling requests for said resource devices in the form of said functional blocks and allocating said resource devices to perform a function of said functional blocks.

18. The computer-readable carrier of claim 17, wherein said step of allocating resource devices further comprises:
translating functional block behaviour requests into specific commands for said resource devices in a device manager.

19. The computer-readable carrier of claim 17, wherein said step of requesting functional blocks comprises one of requesting a radio frequency modulator, upconverter, encryptor, inserter, multiplexer, jitter buffer, quality of service sharper, and transcoder function.

20. The computer-readable carrier of claim 15, wherein said step of delivering said digital data to said end user device further comprises sending said digital data to a node group.

21. The computer-readable carrier of claim 20 , wherein said step of delivering said digital data to said node group further comprises sending said digital data from said node group to said end user device.

22. A service application management subsystem for delivering digital data to end user devices over a network, said system comprising:
at least one transmitter for sending a request, to a delivery network subsystem, for data delivery to at least one end user device; said request structured in a manner such that said at least one end user device can access said digital data; and
a receiver to receive a source input identifier from said delivery network subsystem; said at least one transmitter sending said digital data to said source input for delivery of said digital data to said at least one end user device.

23. The system of claim 22, wherein said request is in the form of generic, high-level, resources; said request being used by said delivery network subsystem to map said request into functional blocks corresponding to unique resource devices used by said delivery network subsystem to deliver said digital data to said at least one end user device.

24. The system of claim 23, wherein said functional blocks comprise one of a radio frequency modulator, upconverter, encryptor, inserter, multiplexer, jitter buffer, quality of service sharper, and transcoder function.

25. A delivery network subsystem for delivering digital data to end user devices over a network, said system comprising:
at least one receiver for receiving a request, from a service application management subsystem, for resources for digital data delivery to at least one end user device; and for receiving said digital data from said service application management subsystem for delivery to said at least one end user device; and
at least one transmitter for selectively delivering said digital data to a requesting end user device in response to said request from said service application management subsystem

26. The system of claim 25, wherein said at least one transmitter sends a source input identifier to said service application management subsystem.

27. The system of claim 25, wherein said request is in the form of generic, high-level, resources; said request being used by to map said request into functional blocks corresponding to unique resource devices used to deliver said digital data to said at least one end user device.

28. The system of claim 27, wherein said functional blocks comprise one of a radio frequency modulator, upconverter, encryptor, inserter, multiplexer, jitter buffer, quality of service sharper, and transcoder function.
